(19) United States
(12) Patent Application Publication
(10) Pub. No.: US 2020/0102095 A1
(43) Pub. Date: Apr. 2, 2020

(54) DEVICE FOR PROVIDING CONDITIONED AIR TO AN AIRCRAFT

(71) Applicants: thyssenkrupp Airport Solutions, S.A., Mieres (ES); thyssenkrupp AG, Essen (DE)

(72) Inventors: Jose Manuel ARDURA FERNÁNDEZ, Gijon (ES); Antonio MURIAS BERMEJO, Gijón (ES)

(73) Assignees: thyssenkrupp Airport Solutions, S.A., Mieres (ES); thyssenkrupp AG, Essen (DE)

(21) Appl. No.: 16/497,889

(22) PCT Filed: Mar. 23, 2018
(86) PCT No.: PCT/EP2018/057481

§ 371 Date: Sep. 26, 2019

(30) Foreign Application Priority Data
Apr. 5, 2017 (EP) 17380010.3

(51) Int. Cl. B64F 1/36

(52) U.S. Cl. CPC B64F 1/362

(57) ABSTRACT

A device that provides conditioned air to an aircraft may include a housing with a housing outlet end, a longitudinally collapsible hose that has a hose outlet for attachment to the aircraft and is partially received within the housing, a hose drive for extracting and retracting the hose by selectively pushing the hose in an outward or inwards directions, a drive control for controlling the hose drive, an outward marker attached to the hose, and a sensor for detecting the presence of the outward marker. The hose may have an extracted length that is at least twice a length of the housing. The hose may pass through the housing outlet end. The drive control may be adapted to respond to signals from the sensor to control the hose drive. Further, the marker may be adapted to provide a magnetic signal or a radio signal for detection by the sensor.

The invention refers to a device for providing conditioned air to an aircraft installed at an airport gate.

Devices of the generic type are described in WO 2014 108590 A2, US 2002/0195156 A1 and US 2009/0197516 A1. In particular US 2009/0197516 A1 discloses a device of the generic type, an optical sensor is used for detecting the position of the hose during use, in particular to detect if the hose is in its fully extracted or retracted position. Thereby a reflective marker is provided at the hose, which cooperates with the sensor. During use the marker is often in contact with the ground and is thereby ripped off after a period of time; also dirt pollutes the strip, thus decreasing the reliability of the sensor. The result is damage to the hose and the hose drive, since the drive does not stop operation, even if the hose is in the fully retracted or extracted position.

It is an object of the invention, to improve the existing devices for providing conditioned air to an aircraft, in particular to make the device more robust against the heavy environmental conditions of an airport such as environmental load and mechanical loads. This object is solved by a device according to claim 1 and a use according to claim 5; preferred embodiments are subject of the subclaims and the description.

The inventive device is adapted to provide conditioned air to an aircraft, comprising
a housing having an housing outlet end,
a longitudinally collapsible hose at least partially accommodated within said housing, the hose having a hose outlet end to be attached to the aircraft ,
a hose drive adapted for extracting the hose out of and retracting the hose into the housing, the hose drive is adapted to contact the surface of the hose to selectively push the hose in a first direction outward from the housing or pull the hose in a second direction inwards to the housing,
a drive control for controlling the hose drive,
an outward marker attached to the hose,
at least one sensor for detecting the presence of said outward marker,
   wherein the hose comprises an extracted length at least twice the length of the housing. The hose passes through the housing outlet end, the drive control is adapted to respond to signals from said sensor to control the hose drive. The outward marker is adapted to provide a magnetic signal or a radio signal to the sensor, to which the sensor is sensitive.

The outward marker providing a radio or magnetic signal can be constructed to be more robust against damage. Pollution is not critical anymore, since the outward marker does not work on an optical basis, as the device according to the prior art does. This increases the overall reliability of the device.

In an embodiment the outward marker is covered by an outside surface of the hose. The outside surface of the hose serves as a protective element against damage. In an embodiment the hose comprises a hose material and the outward marker is integrated in the hose material, in particular, it is sewed into the hose material.

In an embodiment the control unit is adapted to stop operation of the hose drive if the sensor detects that the outward marker has reached a predefined position compared to the sensor.

The device is used in particular in a manner in which the longitudinal section of the hose covering the outward marker, is dragged along a stony floor of the airport. The inventive device is robust enough to provide solid function also during such usage. Thereby initially the hose outlet end is located proximate to the housing outlet end, subsequently the hose is pulled away from the housing outlet end supported by the drive unit, subsequently the outlet end is connected to an airplane input end.

The invention is described in more detail with the help of the figures, shown schematically herein:

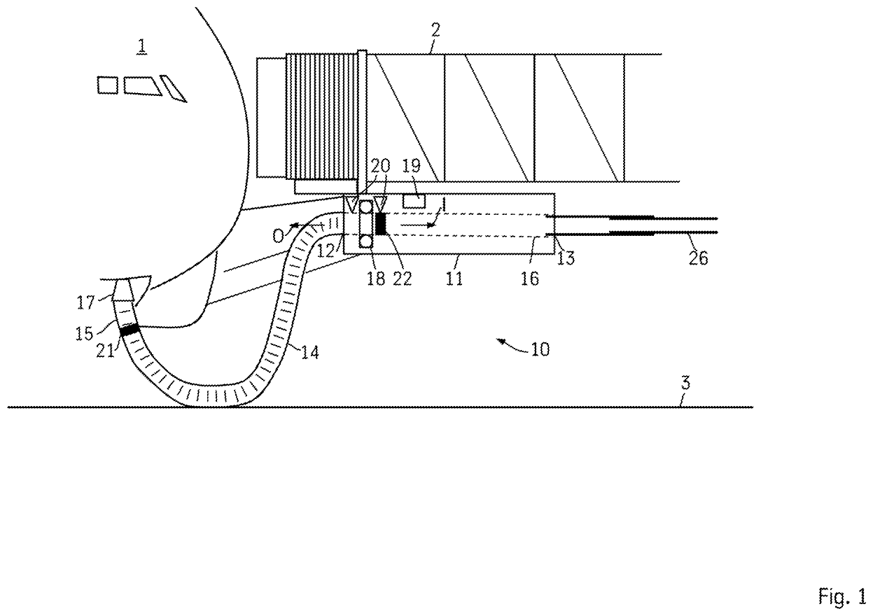

FIG. 1 shows a generic apparatus for extracting and retracting an air conditioning hose installed at an airport;

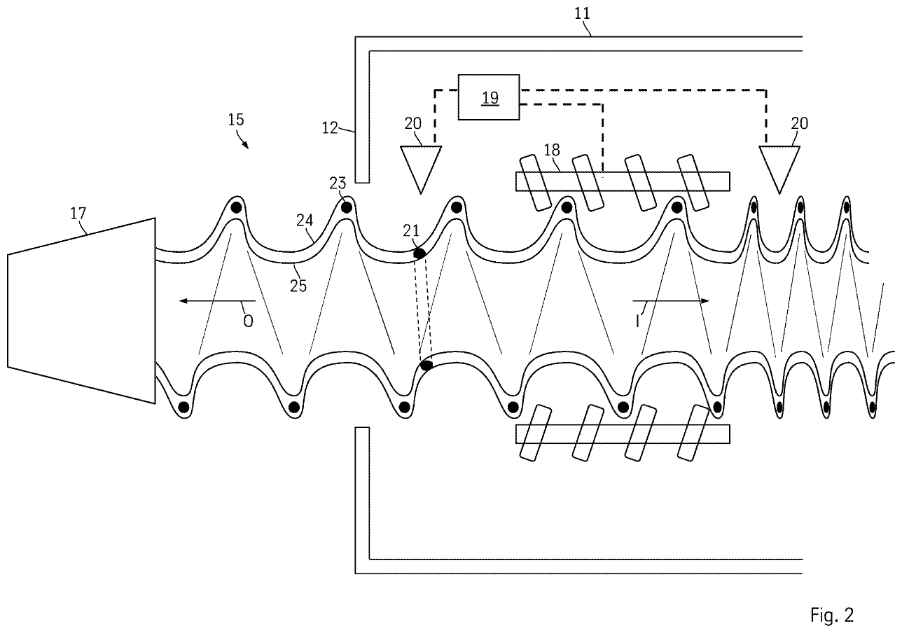

FIG. 2 shows the details of the device of FIG. 1.

FIG. 1 shows an aircraft 1 during a usual situation located at a gate of an airport. The aircraft 1 is standing with its wheels on the airport apron ground 3. A passenger boarding bridge 2 is docked to the aircraft 1.

Attached to the passenger boarding bridge 2 is an inventive device 10 adapted to provide conditioned air to the aircraft 10. The device 10 comprises a hose 14 having an outlet end 15 with a nozzle 17, the nozzle 17 is adapted to be attached to the airplane 1. The hose 14 having an inlet end 16 located to receive conditioned air from a telescopable supply tube 26 or a flexible supply hose (not shown).

The device 10 comprises a housing 11 for accommodating the hose 14 in a retracted position. Within the housing 11 a hose drive 18 is installed for pushing the hose 14 in an outward direction O or to pull the hose 14 in an inward direction I. The hose drive 18 is located in the near of a housing outlet end 12, so the sections of the hose 14, which are pushed by the hose drive 18, are pushed through the outlet end 12 to the outside of the housing 11. A housing inlet end 13 is opposite to the housing outlet end 12; the tube 26 is attached to the housing inlet end 13.

In the extracted position as shown in FIG. 1, a technician can take the freely suspended hose outlet end 17 and connect it to the aircraft 1 via the nozzle 17. If the hose is in the retracted position, then nearly the complete hose 14 is accommodated within the housing 11. Merely a small length of the hose and the nozzle 16 may be located outside of the housing. It is preferred that in the retracted position the hose 14 is short enough, so that the hose 14 is not lying on the apron ground 3. Thus during movement of the passenger boarding bridge 2 the hose 14 is not dragged along the apron ground 3.

The device 10 comprises a drive control 19, i.e. a microcomputer, which controls the function of the hose drive 18 based on user input. Further at least one sensor 20 (here two sensors) is provided at the outlet housing end. This sensor 20 cooperates with markers 21, 22 attached to the hose. So the sensor 20 detects the presence of the respective marker 21, 22. Based on the sensor signals information about the position of the hose are obtained. If the sensor 20 detects the presence of the inward marker 22, then the hose 14 is fully extracted, as shown in FIG. 1. If the sensor 20 detects the presence of the outward marker 21, then the hose is fully retracted (see FIG. 2). Based on the sensor signal the drive control 19 can overrule a user input and force the drive unit 18 to stop.

In general the above described apparatus may have some features of the devices as these are described in WO 2014 108590 A2, US 2002/0195156 A1 and US 2009/0197516 A1, the complete disclosures of which are herein incorporated by reference.

FIG. 2 shows the housing 11 and parts of the hose 14 in more detail. Here the hose 14 is illustrated in its fully retracted position. The nozzle 17 is located closely to the housing outlet end 12, so that no part of the hose 14 is touching the ground 3. The outward marker 21 is in overlapping condition with the sensor 20. The drive control 19 stops any further movement of the hose 14 in inward direction I.

The hose 14 comprises a hose body with an outside surface 24 and an inside surface 25. The outside surface 24 may be made from a robust material; the inner surface 25 may be made from an air tight material. A spiral coil is wound around the hose body 24, 25. The hose drive 18 may comprise a number of worm wheels as described in EP 2944573 A2, interacting with the coils, or any other suitable drive means.

According to the invention the outward marker 21 (as well as the inward marker 22, not shown in FIG. 2) is covered by the outside surface 24. To enable that the sensor can detect the presence of the outward marker 21, the outward marker is a permanent magnetic element, in particular a strip wound around the circumference of the hose. The magnetic field of the marker 21 can pass the outside surface 24. The sensor 20 is a hall sensor detecting the presence of the marker 21 through the outside surface 24. The marker 21 is thus protected against dirt and mechanical loads, thereby providing a long service life. In an embodiment the outside surface may only cover a limited area of the hose in which the marker is located- it is not essential that the outside surface extends over the entire length of the hose.

In a preferred embodiment the nozzle comprises a handle, at which the technician can grasp the nozzle. Further at the nozzle a control button is provided through which the technician can give control commands to the hose drive 18 or the drive control 19, in particular “a start pulling” or “start pushing” command. Preferably the control button and the handle is arranged in a way that the technician can grasp the handle with at least one hand and at the same press the button with a finger of the same hand.

Not shown but provided is a swivel element between the hose inlet end 13 and the supply tube 26. The hose is connected with the bearing which actually belongs to the housing 11. The tube 26 is connected with the outer part of the housing 11 by means of a flexible connection. This allows the hose to freely rotate within the housing compared to the tube 26 and/or the stationary housing inlet end 13 and thus compensates for any torsional stresses within the hose 14, in particular those caused by the drive 18.

### REFERENCE SIGNS LIST

1 plane

2 passenger boarding bridge

3 apron ground

10 device adapted to provide conditioned air to an aircraft

11 housing

12 housing outlet end

13 housing inlet end

14 hose

15 hose outlet end

16 hose inlet end

17 nozzle

18 hose drive

19 drive control

20 sensor

21 outward marker

22 inward marker

23 enforcing structure / coil spring

24 outside surface of hose

25 inside surface of hose

26 supply tube

O outward direction

I Inward direction

1.-6. (canceled)

7. A device configured to provide conditioned air to an aircraft, the device comprising:
a housing having a housing outlet end;
a hose that is longitudinally collapsible and at least partially received within the housing, the hose having a hose outlet end that is attachable to the aircraft, wherein the hose has an extracted length that is at least twice a length of the housing, wherein the hose passes through the housing outlet end;
a hose drive configured to extract the hose out of and retract the hose into the housing, the hose drive being configured to contact a surface of the hose to selectively push the hose in a first direction outward from the housing or pull the hose in a second direction inwards to the housing;
an outward marker attached to the hose;
a sensor for detecting a presence of the outward marker, wherein the outward marker is configured to provide a magnetic signal or a radio signal for detection by the sensor; and
a drive control for controlling the hose drive, wherein the drive control is configured to respond to signals from the sensor to control the hose drive.

8. The device of claim 7 wherein the outward marker is covered by an outside surface of the hose.

9. The device of claim 7 wherein the hose comprises a hose material, wherein the outward marker is integrated in the hose material.

10. The device of claim 7 wherein the outward marker is sewn into a hose material of the hose.

11. The device of claim 7 wherein the drive control is configured to stop operation of the hose drive based on proximity of the outward marker to the sensor.

12. A method for providing conditioned air to an aircraft, the method comprising:
extracting and retracting a hose that is longitudinally collapsible from a housing having a housing outlet end, wherein the hose has a hose outlet end that is attachable to the aircraft, wherein the hose passes through the housing outlet end;
detecting with a sensor a presence of an outward marker attached to the hose, wherein the outward marker is configured to provide a magnetic signal or a radio signal for detection by the sensor; and
controlling a hose drive based on signals from the sensor, wherein the hose drive is configured to contact a surface of the hose to selectively push the hose in a first direction outward from the housing or pull the hose in a second direction inwards to the housing.

13. The method of claim 12 comprising dragging a longitudinal section of the hose that covers the outward marker along a stony floor at an airport.

14. The method of claim 12 comprising:
pulling the hose away from the housing outlet end;
supporting the hose with the hose drive; and
connecting the hose outlet to the aircraft.
